(19) United States
(12) Patent Application Publication
(10) Pub. No.: US 2016/0241697 A1
(43) Pub. Date: Aug. 18, 2016

(54) Removable Digital Photo Frame with Multi-Network Cordless Handset

(71) Applicant: Bennett Hepburn, Norcross, GA (US)

(72) Inventor: Bennett Hepburn, Norcross, GA (US)

(21) Appl. No.: 14/625,304

(22) Filed: Feb. 18, 2015

(51) Int. Cl. H04M 1/725; H04W 4/14; H04L 29/12; H04W 4/00

(52) U.S. Cl. CPC H04M 1/7253; H04W 4/008; H04W 4/14; H04L 61/2567

(57) ABSTRACT

A removable digital photo frame with multi-network cordless handset on a charging base unit housing a computer with a multi-tasking operating system (OS) executing the seven-layer OSI model of computer networking, coupled to VoIP and CTI for wired Ethernet or wireless circuits bridging communication with standard digital telephones, the computer networking Voice-over Internet Protocol phone interface and Computer-Telephony integrated standards communication protocol for the purposes of computer telephony of mobile and Internet integrated with a handset and photo frame display unit.

### BACKGROUND

1. Field of the Invention

The present invention is relates generally to the fields of digital photo frames and telephony, and specifically to .more effective management and sharing of digital photos, contacts, calls, voice and video mail messages via telephony accounts.

2. Background Description

Recent advancements in telephony and digital camera photo and smartphone have made it possible for many consumer produce/service market offerings. However, a technological rift exists between digital photo and message sharing and traditional telephony hands sets

Technological Convergence is defined as the interlinking of previously separate computing and other information technologies, media content and communication networks that have arisen as the result of the evolution and popularization of the Internet; as well as the activities, products and services that have emerged In the digital media space. Technologies such as voice, data, photo and video now share common resources and interact with each other with new synergistic, efficiencies like never before. However, many of the most common technologies still do not communicate with each other, forcing the user to manually execute tasks that should be automated. Photos or videos taken with the user's camera or mobile phone are not available for others to view until the user downloads them. The telephone central exchange models mean messages received on the user's mobile phone are not delivered to the user's home phone. Instant Messages delivered to an online account go unanswered until the user logs into the service again,

What is needed is a bridge to facilitate technological convergence between current telephony more modem consumer digital phone devices and functions.

### SUMMARY

The present invention discloses a removable digital photo frame with multi-network cordless handset on a charging base unit. The system comprises a charging base unit housing a computer with a multi-tasking operating system (OS) executing the seven-layer OSI model of computer networking with computer networking coupled with telephony protocol adaptor and interface components and logic, Ethernet, PSTN phone adaptor. Voice-over Internet Protocol phone interlace and Computer-Telephony integrated standards communication protocol VoIP and CTI components and logic are communicatively coupled, to at least one IP network having wired Ethernet or wireless circuits compatible with standard digital phones, the IP network and contacts with the components and logic to coupled to a conventional PSTN telephone adaptor connected to a modular phone jack. The charging base housing has Integrated Session Traversal Utilities (STUN) components, logic and protocol provide the functions for base unit host to discover its public IP address if it is located behind a Network Address Translator (NAT) permitting traversal for applications of real-time voice, video, messaging, and other interactive Internet Protocol (IP)communications beyond its immediate local network. The multi-network cordless handset unit is electronically coupled to the base unit in a cradle, handset integrating input-output and processing devices such as earpiece, keypad, microphone, camera, wireless communication components for signal such as Wi-Fi, Bluetooth, or any other viable wireless technology for coupling with local computer VOIP services or base unit PSTN, Internet chat and video chat communication components and logic, screen display, navigation pad and other typical handset components and attributes. The removable digital photo frame unit is electronically and electronically coupled to the Charging base unit in a docking cradle having a standard digital photos and/or video touch screen display, with components and logic for wireless communication for synching to a network computer, removable digital storage media, and components and logic for wired or wireless communication photo/video transfer between the base and the digital photo frame unit and between the base unit and the cordless handset, whereby the Multi-Network Cordless Handset may be paired via a wireless to a local network computer permitting traversal for applications of real-time voice, video, messaging, and other interactive Internet Protocol for communication through the digital frame unit.

### BRIEF DESCRIPTION OF DRAWINGS

Specific embodiments of the invention will be described in detail with reference to the following figures.

FIG. 1 is a front view illustration of a Charging Base, containing a docked Removable Digital Photo Frame and a docked Multi-Network Cordless Handset, according to the embodiment of the present invention.

If FIG. 2 is a top view illustration of the Charging Base, according to the embodiment of the present invention.

FIG. 3 is an illustration of a Multi-Network Cordless Handset, according to the embodiment of the present invention.

FIG. 4 is an illustration of the Multi-Network Cordless Handset being used as a Camera Phone.

FIG. 5 is an illustration of the Removable Digital Photo Frame, according to the embodiment of the present invention.

FIG. 6 is a bottom and side illustration of the Removable Digital Photo Frame.

### DETAILED DESCRIPTION

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

### OBJECTS AND ADVANTAGES

An objective of the invention is to create a more effective management and sharing of digital photos, video, audio and other digital files.

Another objective of the invention is to provide the user a more effective system in managing there telephony/phone contacts, calls, voice messages, video communications and video mail messages from their landline, mobile phone and Voice-Over internet Protocol ( VOIP) accounts.

Yet another objective is to create a more modern user's home phone, VOIP Phone and will accept calls pushed from the users mobile phone.

Another object of the Invention is to provide the user facilities to display photos and videos taken with their digital camera or mobile phone in a central location.

An object of the invention is to provide facility for a the user to automatically upload new photos to their social networking sites.

Another object of the invention will provide the user with facility to view and respond to voice, text, photo and video messages, whether sent from the user's mobile phone, home phone or computer. Such an invention will allow the user to share photos and video with family and friends, who also have the device.

### EMBODIMENTS OF THE INVENTION

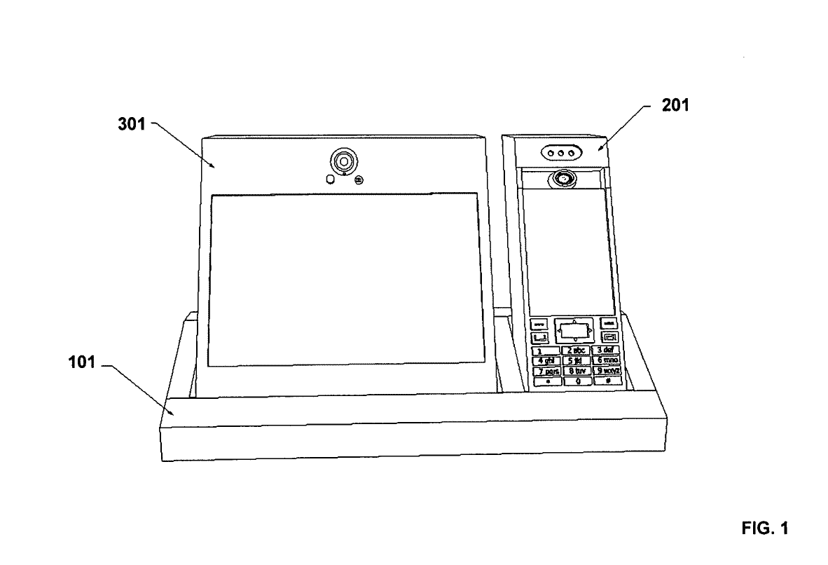

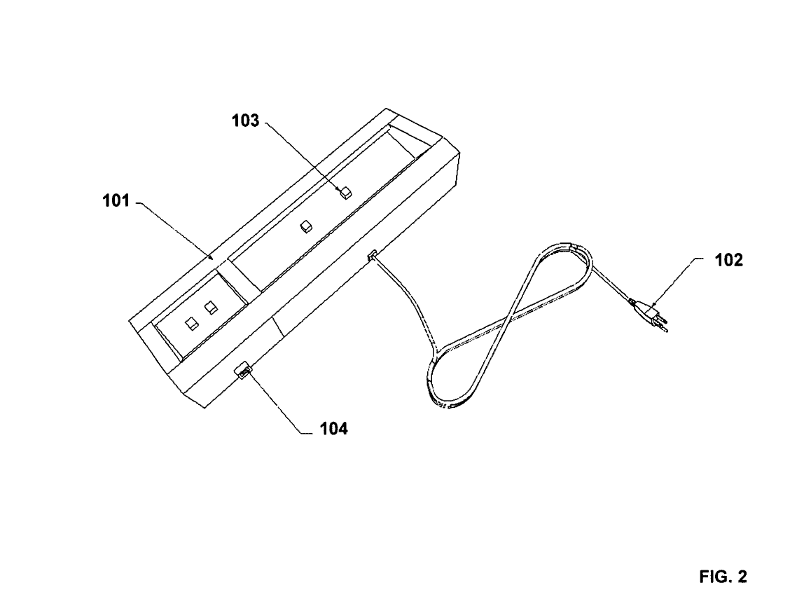

FIG. 1 is a front view illustration of a Charging Base 101, containing a docked Multi-Network Cordless Handset 201, and a docked Removable Digital Photo Frame 301 having a laptop form factor display electronically coupled to the base unit in a cradle, according to the embodiment of the present invention. In one embodiment, both the docked Multi-Network Cordless Handset and the docked Removable Digital Photo Frame may be removed from the Charging Base, and may be used as separate components.

The Charging Base 101 houses the components and logic for dedicated Voice-Over Internet Protocol (VoIP) phone connections via the Computer-Telephony integrated (CTI) and VoIP standards communication, components and logic directly to the IP network having component and protocols for wired Ethernet or wireless circuits typically designed in typical digital telephones. The interface, components and logic are coupled to legacy public standard telephone network (PSTN) analog telephone adapter coupled to the network contacts and provide the components and logic to operate a conventional analog telephone attached through a modular phone jack. Charging base housing 101 contains integrated Session Traversal Utilities components, logic and protocol provide the functions for base unit host to discover its public IP address if it is located behind a Network Address Translator permitting traversal for applications of real-time voice, video, messaging, and other interactive Internet Protocol (IP)communications. A multi-tasking operating system executing the seven-layer OSI model of computer networking is included to provide the environment and organization for programmatic use of available communication technology and applications at the application level. floor mounted telephone socket In the user's home or business. In this embodiment, the user may use Multi-Network Cordless Handset in the same manner as a standard telephone.

### The Charging Base 101

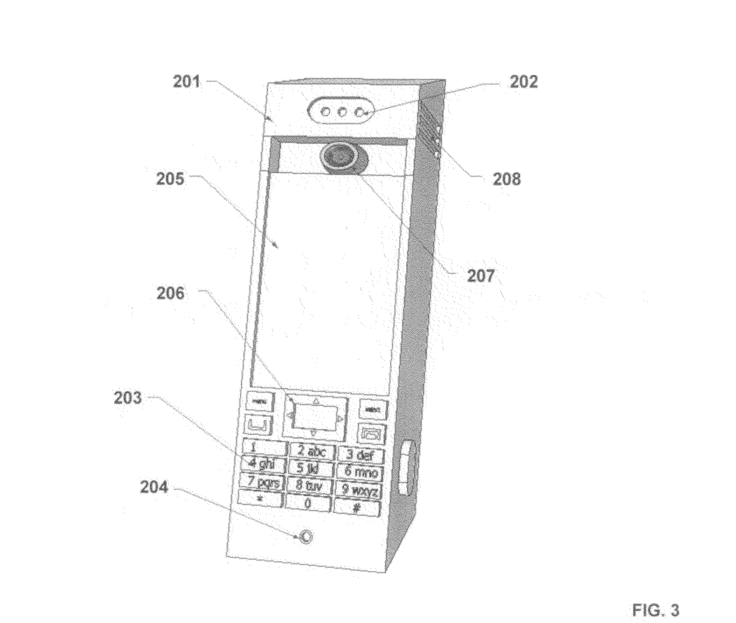

FIG. 3 is an illustration of the Multi-Network Cordless Handset 201, according to the embodiment of the present invention. In one embodiment, the Multi-Network Cordless Handset may include Earpiece 202, Keypad 203 and Mic 204, and may be used in the same manner as a standard telephone. In another embodiment, the Multi-Network Cordless Handset may be paired via a wireless signal such as Wi-Fi, Bluetooth, or any other viable wireless technology, to the user s computer and may be used as a VOIP Phone. In this aspect of the invention, the Multi-Network Cordless Handset may be used with VOIP services such as BroadVoice, Skype™, Vonage™, etc. as a VOIP Phone.

In another embodiment, the Multi-Network Cordless Handset may he paired

via a wireless signal such as Wi-Fi, Bluetooth, or any other viable wireless technology, to the user's computer and may be used as an Internet Chat Phone. In this embodiment, the user may log onto and load their contact list(s) from their Chat Services). In this embodiment, the user's contacts may be displayed on the Screen 205, of the Multi-Network Cordless Handset. In this embodiment, the user may use Navigation Pad 206, to scroll through and select a contact from their contact list. In this embodiment, the user may engage in an Internet Chat with an online contact without being in front of their computer. In this aspect of the invention, the Multi-Network Cordless Handset may be used with Internet Chat Services such as AOL Instant Messenger™, Google Talk™, Yahoo! Messenger etc. as an internet Chat Phone.

In another embodiment, the Multi-Network Cordless Handset may be paired via a wireless signal such as Wi-Fi, Bluetooth, or any other viable wireless technology to the user's computer and may be used as a Video Chat Phone. In this embodiment, the user may log onto and load their contact list(s) from their Video Chat Service(s). In this embodiment, the user's contacts may be displayed on the Screen 205, of the Multi-Network Cordless Handset In this embodiment, the user may use Navigation Pad 206, to scroll through and select a contact from their contact list. In this embodiment, the user may then use Frost Facing Camera 207, to engage in a Video Chat with an online contact without being In front of their computer. In this aspect of the invention, the Multi-Network Cordless Handset may be used with Video Chat Services such as AOL Instant Messenger™, Google Talk™, Yahoo!™ Messenger, etc. as an Internet Chat Phone.

In another embodiment, the Multi-Network Cordless Handset may be paired via a wireless signal such as Wi-Fi, Bluetooth, or any other viable wireless technology, to the user's mobile phone. In this embodiment, the Multi-Network Cordless Handset may also ring and display Caller I D information when the user's paired mobile phone rings, hi an aspect of the invention, if the user is not able to quickly locate their mobile phone, the user may answer an incoming call from their paired mobile phono via the Multi-Network Cordless Handset.

In another embodiment, the user may access and view their contact list(s), as well as place out-going calls from their paired mobile phone via the Multi-Network Cordless Handset. (In this example, the call may be re-routed through the users VOIP or Landline Service, thus saving the riser's mobile minutes.) In another embodiment, the user may use the Multi-Network Cordless Handset to access, view and respond to text messages, SMS, and/or photos from their paired mobile phone.

The Multi-Network Cordless Handset may also contain Speaker 208, according to the embodiment of the present invention. In another embodiment, when using the Multi-Network Cordless Handset as either a Landline, a VOIP Phone and/or an Internet Chat Phone, the user may TURN ON the Speaker to use the Multi-Network Cordless Handset as a hands-free device. In another embodiment, user may set the Multi-Network Network Cordless Handset to display Photo Caller ID of callers from incoming Landline calls, VOIP Calls, Internet Chat Calls and/or Video Chat Calls.

In another embodiment, the user may pair a Bluetooth headset to the Multi-Network Cordless Handset via a Bluetooth signal. In this embodiment, the user may then use the paired Bluetooth headset to place and/or receive hands-free calls when using the Multi-Network Cordless Handset as either a Landline, a VOIP Phone, an Internet Chat Phone and/or a Video Chat Phone. This embodiment precludes having to purchase a separate headset for a landline and may pair any Bluetooth equipped headset to the Multi-Network Cordless Handset.

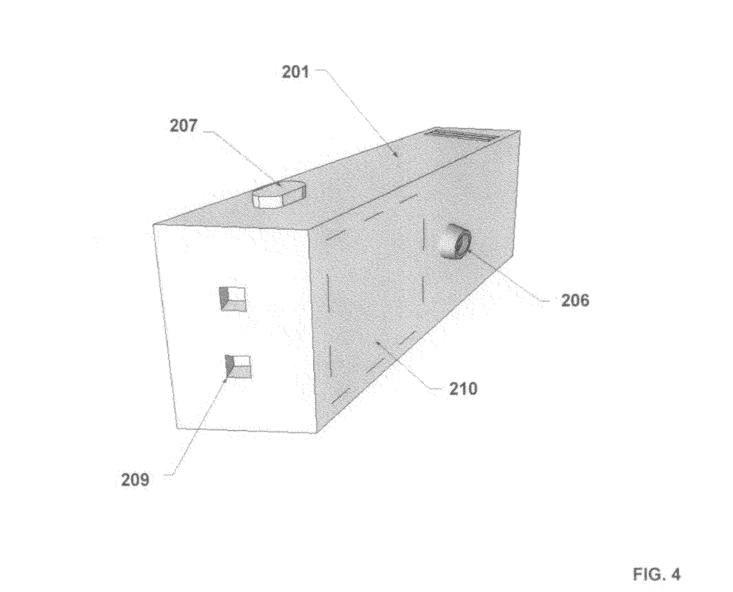

FIG. 4 is an illustration of the Multi-Network Cordless Handset 201, being used as a Camera Phone, according to the embodiment of the present invention. In another embodiment, user may use the Multi-Network Cordless Handset as a Camera Phone to take photos and/or videos, in one embodiment, the user may use Navigation Pad 203, to select “Camera Mode”. User may then tarn the Multi-Network Cordless Handset horizontally and may point Digital Camera Lens 206, at their intended photo subject. In one embodiment, the photo subject may appear on Screen 202, which may now serve as a viewfinder. In one embodiment, the user may use the numeric keypad to ZOOM IN and/or OUT on their photo subject. In one example, the user may use the “# Button” to ZOOM IN and the “* Button” to ZOOM OCT. In another embodiment, the user may slide a finger UP and/or DOWN the Screen to ZOOM IN and/or OUT on their photo subject. Once the photo subject is framed, the user may then press Photo Capture Batten 207, to take the photo. In another embodiment, the user may hold down the Photo Capture Button to record a video. The user may then use the Multi-Network Cordless Handset to send and/or receive photos and/or videos to and from other Multi-Network Cordless Handsets, mobile phones, Internet Chat Services and/or Video Chat Services.

In another embodiment, the Multi-Network Cordless Handset may also contain Component Contact Point(s) 209. In one embodiment, the Multi-Network

The IP network is supported by components, logic and protocol for passing data packets between network connections. A stripped down rooter may be connected to two or more data lines from different networks. When a data packet comes in one of the networks, the router reads the address information in the packet to determine its ultimate destination and directs the packet to the network in the destination data be it web pages, email, IM, chat, and videos between the base computer and the Internet, cable or a DSL router. The charging base will include integrated components and logic for wired or wireless communication between the base and the digital photo frame unit and between the base unit and the cordless handset, such that the Multi-Network Cordless Handset may be paired via a wireless to a local computer permitting traversal for applications of real-time voice, video, messaging, and other interactive Internet Protocol and VoIP for communication, through the digital frame and handset units.

Likewise softphone applications are installed on the base networked computer equipped with typical input-output devices including a microphone, speaker, mouse, fingerpad, input-output display, touchscreen, keyboard or headset.

FIG. 2 is a top rear-view illustration of the Charging Base 101, according to the embodiment of the present invention. In one embodiment, the Charging Base may contain AC Plug 102. In this embodiment, AC Plug may be plugged into an electrical outlet and may supply electrical power to the Charging Base. Charging Base may also contain Charging Contact Point 103. In one embodiment, the Multi-Network Cordless Handset and/or the Removable Digital Photo Frame may be placed in their respective dock(s), in such a way that their Component Contact Points) come Into contact with the Charging Contact Point(s) of the Charging Base, in this embodiment, electricity may pass between the Charging Contact Point(s) and the Component Contact Point(s) to charge an Internal Battery contained in the Multi-Network Cordless Handset and/or the Removable Digital Photo Frame. In another embodiment, Charging Base may also contain Telephone Jack 104, In this embodiment, one end of a standard telephone cable may be plugged into the Telephone Jack and the other end may be plugged into a wall or Cordless Handset may be placed in its dock in such a way that the Component Contact Point(s) come into contact with the Charging Contact Point(s) of the Charging Base. In this embodiment, electricity may pass between the Charging Contact Point(s) and the Component Contact Point(s) to charge Internal Battery 210, contained in the Multi-Network Cordless Handset.

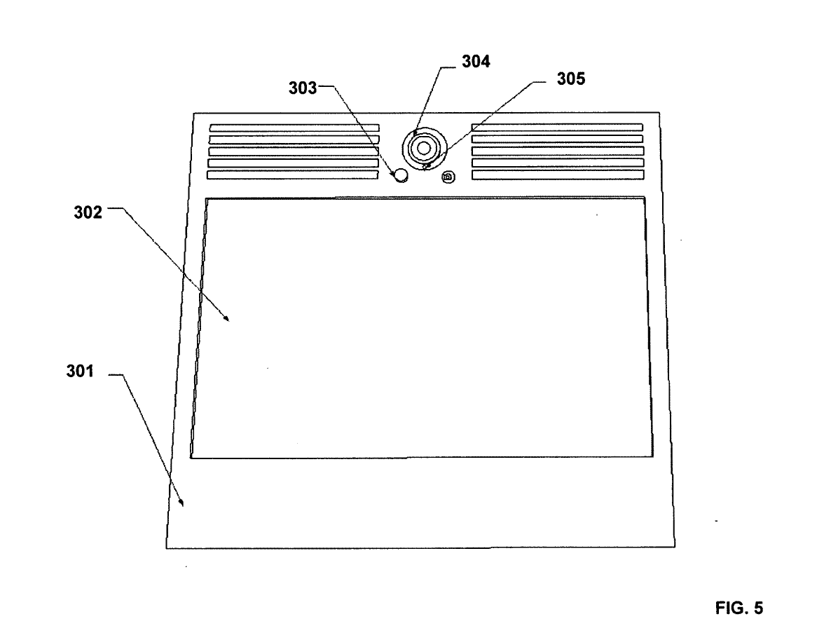

FIG. 5 is an illustration of the Removable Digital Photo Frame 301, according to the embodiment of the present invention. In one embodiment, the Removable Digital Photo Frame may be docked into the Charging Base 101, and may used in the same manner as a standard digital photo frame to display photos and/or videos on its Touchscreen 302. In another embodiment, the user may remove the Removable Digital Photo Frame from the Charging Base and use it as a portable device.

In another embodiment the Removable Digital Photo Frame may be paired to the user's computer, digital camera and/or mobile phone via a wireless signal such as Wi-Fi, Bluetooth, or any other viable wireless technology. In this embodiment, the Removable Digital Photo Frame may periodically check the users computer, digital camera and/or mobile phone for new photos and/or videos. In one embodiment, the Removable Digital Photo Frame may automatically download new photos and/or videos from the user's computer, digital camera and/or mobile phone to display on its Touchscreen. In another embodiment, the Removable Digital Photo Frame may prompt the user to manually download any new photos and/or videos that it finds on the user's computer, digital camera and/or mobile phone.

In yet another embodiment, the Removable Digital Photo Frame may communicate with other Removable Digital Photo Frames in the user's home or business to periodically check tor new photos and/or videos. In another embodiment, the Removable Digital Photo Frame may automatically download new photos and/or videos from other Removable Digital Photo Frames. In another embodiment, the Removable Digital Photo Frame may prompt the user to manually download any new photos and/or videos that it finds on other Removable Digital Photo Frames.

In another embodiment, the user may set the Removable Digital Photo Frame to share user selected photos and/or videos with other Removable Digital Photo Frame(s). (In this example, the user may share selected photos and/or videos with family members or friends living in another city, state or country who also have a Removable Digital Photo Frame.) In one embodiment, photo and/or video sharing may take place over a wireless connection such as Wi-Fi or Wi-Max (or any other viable type of wireless connection). In another embodiment, photo and/or video sharing may take place over the landline connection, if so equipped. In another embodiment, the Removable Digital Photo frame may access the user's computer and share user selected photos and/or videos via an internet connection.

In another embodiment, applications may be downloaded to the Removable Digital Photo Frame which may allow the user to quickly upload photos and/or videos to their social media sites (such as Facebook, Bebo, Friendster, Hi5, etc.). In another embodiment, the user may set different types of transitional animations (such as Page Turn, Fade, Wipe, etc.) for photos and/or videos being displayed on the Removable Digital Photo Frame.

The Removable Digital Photo Frame may also be equipped with Motion Sensor 303. In one embodiment, the Motion Sensor may put Removable Digital Photo Frame into a LOW POWER/SLEEP MODE, when no motion is detected in the room. In another embodiment, the Removable Digital Photo Frame may come out of its low power sleep mode and resume displaying photos when motion is detected in the room. In another embodiment, the Removable Digital Photo Frame may be equipped with an ALWAYS ON feature. In this embodiment, the user DOES NOT have to wait for the Removable Digital Photo Frame to BOOT UP to be able to use it. The user is able to use the Removable Digital Photo Frame immediately after it comes out of low power/sleep mode.

In another embodiment the Removable Digital Photo Frame may be paired to the user's computer (via a wireless signal such as Wi-Fi, Bluetooth, or any other viable wireless technology ), and may fee used as a Video Chat Phone. In this embodiment the user may log onto and load their contact list(s) from their Video Chat Service(s). In one embodiment, the user's contacts may be displayed on the Removable Digital Photo Frame's Touchscreen 302. In this embodiment, the user may use the Touchscreen to scroll through and select a contact from their contact list. In one embodiment, the user may then use Front Facing Camera 364, to engage in a Video Chat with an online contact without being in front of their computer. (In this example, the Removable Digital Photo Frame may be used with Video Chat Services such as Google Talk, Yahoo! Messenger, Skype, etc. as a Video Chat Phone.)

In one embodiment, the Removable Digital Photo Frame may contain Microphone 305. In this embodiment, user's voice may be picked up by the microphone and transmitted to the party on the other end of the Video Chat. The Removable Digital Photo Frame may also contain Speakers 306. In this embodiment, user may hear the audio from their Video Chat and/or video clips through the Speakers.

In another embodiment, the user may pair a Bluetooth headset to the Removable Digital Photo Frame. In this embodiment, the user may then use the paired Bluetooth headset to place and/or receive a hands-free Video Chat. This embodiment precludes the need to purchase a separate headset for the Removable Digital Photo frame, and may pair any Bluetooth equipped headset to the Removable Digital Photo Frame. In this embodiment, the Speakers may be disabled when a Bluetooth headset is used to engage in a Video Chat.

In another embodiment the user may download applications to the Removable Digital Photo Frame that may allow the user to watch streaming video from their computers), television(s), or wirelessly equipped video player(s). In this embodiment the user may stream video from services such as YouTube, Sling Player, etc. or stream a movie from a Netflix equipped DVD player. In another embodiment, the user may use the Removable Digital Photo Frame to listen to internet radio, or to stream music from subscription services such as Rhapsody, Pandora, ShoutCast, Live365, etc.

In another embodiment, the Removable Digital Photo Frame may be paired via a wireless signal such as Wi-Fi, Bluetooth, or any other viable wireless technology to the users computer and may be used as a VOIP Phone. For this embodiment the Removable Digital Photo Frame may be used with VOIP services such as BroadVoice, Skype, Vonage, etc. as a VOIP Phone.

In another embodiment, the Removable Digital Photo Frame may be paired via a wireless signal such as Wi-Fi, Bluetooth, or any other viable wireless technology, to the user's computer and may be used as a Internet Chat Phone. In this embodiment, the user may log onto and load their contact list(s) from their Chat Service(s). In this embodiment, the user's contacts may be displayed on the Removable Digital Photo Frame's Touchscreen 382. In this embodiment, the user may use the Touchscreen to scroll through and select a contact from their contact list. In this embodiment, the user may engage in an Internet Chat with an online contact without being in front of their computer, in this embodiment the Removable Digital Photo Frame may be used with Internet Chat Services such as AOL Instant Messenger, Google Talk, Yahoo! Messenger, etc. as an Internet Chat Phone.

In another embodiment, the Removable Digital Photo Frame may be paired via a wireless signal such as Wi-Fi, Bluetooth, or any other viable wireless technology to the user's mobile phone. In this embodiment, the Removable Digital Photo Frame may also ring and display Caller ID information when the user's paired mobile phone rings. In this embodiment, if the user is not able to quickly locate their mobile phone, the user may answer an incoming call from their paired mobile phone via the Removable Digital Photo Frame.

In another embodiment, the user may access and view their contact list(s), as well as place out-going calls from their paired mobile phone via the Removable Digital Photo Frame. In this embodiment, the call may be re-routed through the users VOIP or Landline Service, thus saving the users mobile minutes.

In another embodiment, the user may use the Removable Digital Photo Frame to access, view, compose and/or respond to text messages, SMS, and/or photos from their paired mobile phone(s), internet chat service(s), email, social media site(s), etc. In one embodiment, the Removable Digital Photo Frame may display a Virtual Keyboard, which the user may use to compose new messages or type responses.

In another embodiment, the user may use the Virtual Keyboard to engage in a Text Chat (In this example, the user may use Text Chat Services such as Google Talk®, Yahoo! Messenger®, Skype®, etc. In another embodiment, the user may use the Virtual Keyboard to access their email contact list and to compose or respond to an email.

In another embodiment, the Removable Digital Photo Frame may record and store the user's voice mail, video mail, photo and text messages from missed Landline, VOIP and/or mobile calls. In one embodiment, the Removable Digital Photo Frame may display the message type with a special icon for each call received. In one embodiment, one call may be marked with a mobile phone icon; while another is marked with a landline icon, and yet another may be marked, with an SMS icon. In another embodiment, the Removable Digital Photo Frame may keep the messages in the order in which they were received, but may allow the user to prioritize which message they listen and respond to first. In this embodiment, the user may have five messages, but may choose to listen to and respond to Message #4 first.

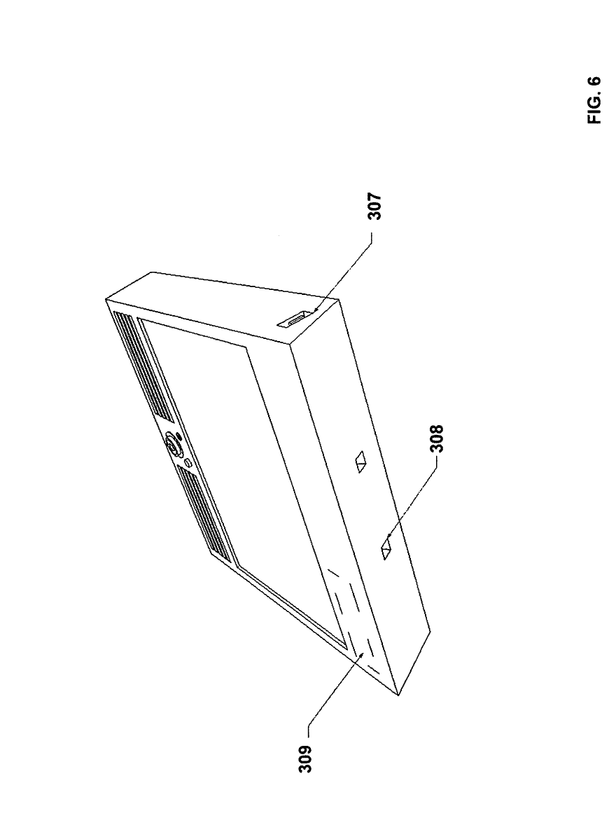

FIG. 6 is a bottom and side illustration of the Removable Digital Photo Frame 301, according to the embodiment of the present invention. In one embodiment, the Removable Digital Photo Frame may contain Removable Media Slot 307. In one embodiment, the user may plug Removable Media, such as USB, Micro USB, SD Card, CF Card, etc, into the Removable Media Slot. In this embodiment, the user may manually transfer photos, audio and video, and/or applications to and/or from the Removable Digital Photo Frame.

In another embodiment, the Removable Digital Photo Frame may also contain Component Contact Point(s) 308. In one embodiment, the Removable Digital Photo Frame may be placed in its dock in such a way that the Component Contact Point(s) come into contact with the Charging Contact Point(s) of the Charging Base. In this embodiment, electricity may pass between the Charging Contact Point(s) and the Component Contact Point(s) to charge Internal Battery 210, contained in the Removable Digital Photo Frame.

Therefore, while the invention has been described with respect to a limited number of embodiments, those skilled in the art, having benefit of this invention, will appreciate that other embodiments can be devised which do not depart from the scope of the invention as disclosed herein. Other aspects of the invention will be apparent from the following description and the appended claims.

What is claimed is:

1. A removable digital photo frame with multi-network cordless handset on a charging base unit comprising;
a charging base unit housing a computer with a multi-tasking operating system (OS) executing the seven-layer OSI model of computer networking,
the computer networking coupled with telephony protocol adaptor and interlace components and logic, Ethernet, PSTN phone adaptor, Voice-over Internet Protocol phone Interface and Computer-Telephony integrated standards communication protocol,
VoIP and CTI components and logic communicatively coupled to at least one I P network having components, logic tor wired Ethernet or wireless circuits compatible with standard digital telephones.,
the IP network and contacts with the components and logic to coupled to a conventional PSTN telephone adaptor connected to a modular phone jack,
charging base housing having integrated Session Traversal Utilities (STUN) components, logic and protocol provide the functions for base unit host to discover its public IP address if it is located behind a Network Address Translator (NAT) permitting traversal for applications of real-time voice, video, messaging, and other interactive Internet Protocol (IP)communications,
a multi-network cordless handset unit electronically coupled to the base unit in a cradle, handset integrating input-output and processing devices such as earpiece, keypad, microphone, camera, wireless communication components for signal such as Wi-Fi, Bluetooth, or any other viable wireless technology for coupling with local computer VOIP services or base unit PSTN, Internet chat and video chat communication components and logic, screen display, navigation pad and other typical handset components and attributes,
a removable digital photo frame unit with laptop form factor display dimension electronically coupled to the base unit in a cradle, the Removable Digital Photo Frame with docking cradle into the Charging Base, having a standard digital photos and/or video touch screen laptop form factor dimension display, with components and logic for wireless communication for synching to a network computer, removable digital storage media, and
components and logic for wired or wireless communication among the base and the digital photo frame unit and the cordless handset,
whereby the Multi-Network Cordless Handset may be paired via a wireless to a local computer permitting traversal for applications of real-time voice, video, messaging, and other interactive Internet Protocol for communication through the digital frame and handset units.

2. The Photo Frame with multi-network handset and base as in claim 1 wherein the Photo Frame unit and handset have wireless protocol components and logic consisting essential of standard wireless protocols front the set of protocols including IEEE, ISO standards, Wi-Fi, Bluetooth, Wi-Max and NFC for the purpose of sharing digital picture and video files from handset digital camera or mobile phone.

3. The Photo Frame with multi-network handset and base as in claim 1 further comprising the Photo Frame unit having logic to periodically check selected local computer(s), digital camera and/or mobile phone(s) for new photos and/or videos and automatically download/upload new photos and/or videos from (he computer, digital camera and/or mobile phone to display on its Touchscreen.

4. The Photo Frame with multi-network handset and base as in claim 1 further comprising the Removable Digital Photo Frame having logic to periodically and programmatically connect with other Removable Digital Photo Frames on the local or other selected networks to periodically synch and check for new photos and/or videos and automatically download new photos and/or videos from preset contact list of Removable Digital Photo Frames for viewing on the downloading Photo Frame.

5. The Photo Frame with multi-network handset and base as in claim 1 further comprising the Removable Digital Photo Frame having programmed logic to programmatically connect with preset streaming of content from a set of content sources consisting essentially of computer, cable enabled television, wirelessly equipped video player, cloud or internet subscription content providers and internet radio.

6. The Photo Frame with multi-network handset and base as in claim 1 further comprising the Removable Digital Photo Frame having programmed logic to programmatically place out-going calls from a paired mobile phone via the such that a call may returned re-routed through the Removable Digital Photo Frame VOIP or Landline Service.

7. The Photo Frame with multi-network handset and base as in claim 1 further comprising the Removable Digital Photo Frame having programmed logic for serving applications on Network layer 7 access, view, compose and/or respond to mobile applications from, a set of mobile applications consisting essentially of texting, SMS, photo/video sharing, from a paired mobile phone, internet chat servicers), email social media site(s) and Virtual Keyboard.

8. The Photo Frame with multi-network handset and base as in claim 1 wherein the Removable Digital Photo Frame having a removable digital storage media i/o slot tor accommodating removable media from the set of plug removable digital storage media consisting of USB, Micro USB, SD Card, and CP Card, for manually transfer of photos, audio and video, and/or applications to and/or from the Removable Digital Photo Frame.

9. The Photo Frame with multi-network handset and base as in claim 1 wherein the handset unit comprises earpiece, keypad, microphone, speaker, front facing camera, out facing camera, wireless communication component functions, VOIP interface, Internet chat phone interlace, display screen, navigation pad, such that the Multi-Network Cordless Handset may be used with Internet Chat, Video Chat and other Network Layer 7 applications, Internet and VoIP services.

10. The Photo Frame with multi-network handset and base as in claim 1 further comprising the handset unit with programmatic logic to access, view and text messages, SMS, chat, photos or voice from a paired mobile phono and re-route responses through VOIP or Landline Service outside of the mobile phone voice data plan.

11. A method of providing removable digital photo frame with multi-network cordless handset on a charging base unit system comprising the steps of:
providing a charging base unit housing a computer with a multi-tasking operating system executing the seven-layer OSI model of computer networking,
coupling the computer networking with a telephony protocol adaptor and interface components and logic, Ethernet, PSTN phone adaptor, Voice-over Internet Protocol phone interlace and Computer-Telephony integrated standards communication protocol,
communicatively coupling the VoIP and CTI components and logic to at least one IP network having components, logic for wired Ethernet or wireless circuits compatible with standard digital telephones,
coupling a conventional PSTN telephone adaptor connected to a modular phone jack to the IP network components and logic,
Integrating the charging base housing with Session Traversal Utilities (STUN) components, logic and protocol provide the functions for base unit host to discover its public IP address if it is located behind a Network Address Translator (NAT) permitting traversal for applications of real-time voice, video, messaging, and other Interactive Internet Protocol (IP) communications.
providing a multi-network cordless handset unit electronically coupled to the base unit in a cradle, handset integrating input-output and processing devices such as earpiece, keypad, microphone, camera, wireless communication components for signal such as Wi-Fi, Bluetooth, or any other viable wireless technology for coupling with local computer VOIP services or base unit PSTN, Internet chat and video chat communication components and logic, screen display, navigation pad and other typical handset components and attributes,
providing a removable digital photo frame unit with laptop form factor display dimension electronically coupled to the base unit in a cradle, the Removable Digital Photo Frame with docking cradle into the Charging Base, having a standard digital photos and/or video touch screen laptop form factor dimension display, with components and logic for wireless communication for synching to a network computer, removable digital storage media, and
integrating components and logic for wired or wireless communication between the base and the digital photo frame unit and between the base unit and the cordless handset,
such that the Multi-Network Cordless Handset may be paired via a wireless to a local computer permitting traversal for applications of real-time voice, video, messaging, and other interactive Internet Protocol and VoIP for communication through the digital frame and handset units.

12. The method of a removable digital photo frame with multi-network cordless handset on a charging base system as in claim 11 further comprising the steps of integrating Photo Frame unit and handset have wireless protocol components and logic consisting essential of standard wireless protocols fern the set of protocols including IEEE, ISO standards, Wi-Fi, Bluetooth, Wi-Max and NFC for the purpose of sharing digital picture and video files from handset digital camera or mobile phone.

13. The method of a removable digital photo frame with multi-network cordless handset on a charging base system as in claim 11 further comprising the steps of integrating the Photo Frame unit having logic to periodically cheek selected local computer(s), digital camera and/or mobile phone(s) for new photos and/or videos and automatically download/upload new photos and/or videos from the computer, digital camera and/or mobile phone to display on its Touchscreen.

14. The method of a removable digital photo frame with multi-network cordless handset on a charging base system as in claim 11 further comprising the steps of integrating the Removable Digital Photo Frame having logic to periodically and programmatically connect with other Removable Digital Photo Frames on the local or other selected networks to periodically synch and check for new photos and/or videos and automatically download new photos and/or videos from preset contact list of Removable Digital Photo Frames for viewing on the downloading Photo Frame.

15. The method of a removable digital photo frame with multi-network cordless handset on a charging base system as in claim 11 further comprising the steps of integrating the Removable Digital Photo Frame logic to programmatically connect with preset streaming of content from a set of content sources consisting essentially of computer, cable enabled television, wirelessly equipped video player, cloud or internet subscription content providers and internet radio.

16. The method of a removable digital photo frame with multi-network cordless handset on a charging base system as in claim 11 further comprising the steps of integrating the Removable Digital Photo Frame having programmed logic to programmatically place out-going calls from a paired mobile phone via the such that a call may returned re-routed through the Removable Digital Photo Frame VOIP or Landline Service.

17. The method of a removable digital photo frame with multi-network cordless handset on a charging base system as in claim 11 further comprising the steps of integrating the Removable Digital Photo Frame logic for serving applications on Network layer 7 access, view, compose and/or respond to mobile applications from a set of mobile applications consisting essentially of texting, SMS, photo/video sharing, from a paired mobile phone, internet chat service(s), email, social media site(s) and Virtual Keyboard.

18. The method of a removable digital photo frame with multi-network cordless handset on a charging base system as in claim 11 further comprising the steps of integrating the Removable Digital Photo Frame with removable digital storage media i/o slot for accommodating removable media from the set of plug removable digital storage media consisting of USB, Micro USB, SD Card, and CF Card, for manually transfer of photos, audio and video, and/or applications to and/or from the Removable Digital Photo Frame.

19. The method of a removable digital photo frame with multi-network cordless handset on a charging base system as in claim 11 further comprising the steps of integrating the handset components to include earpiece, keypad, microphone, speaker, from facing camera, out facing camera, wireless communication component functions, VOIP interface, Internet chat phone interface, display screen, navigation pad, such that the Multi-Network Cordless Handset may he used with Internet Chat, Video Chat and other Network Layer 1 applications, Internet and VoIP services.

20. The method of a removable digital photo frame with multi-network cordless handset on a charging base system as in claim 11 further comprising the steps of integrating the handset unit with programmatic logic to access, view and text messages, SMS, chat, photos or voice front a paired mobile phone and re-route responses through VOIP or Landline Service outside of the mobile phone voice data plan.
